(19) United States
(12) Patent Application Publication
(10) Pub. No.: US 2007/0115138 A1
(43) Pub. Date: May 24, 2007

(54) Onboard imaging apparatus

(76) Inventor: Kenji Arakawa, Kyoto (JP)

Correspondence Address: MCDERMOTT WILL & EMERY LLP, 600 13TH STREET, N.W., WASHINGTON, DC, 20005-3096, US

(21) Appl. No.: 11/600,056

(22) Filed: Nov. 16, 2006

(30) Foreign Application Priority Data
Nov. 16, 2005 (JP) 2005-331258

(51) Int. Cl. G08G 1/00; B60Q 1/00; H04N 7/18

(52) U.S. Cl. 340/901; 340/435; 348/148

(57) ABSTRACT

The sight in front of a vehicle is picked up by an onboard imaging apparatus, and the picked up image is displayed on an onboard display device arranged at a position that is visually recognizable from a following vehicle of the leading vehicle.

### BACKGROUND OF THE INVENTION

1. Field of the Invention

The present invention relates to an onboard imaging apparatus that displays an image in a frontward of vehicle, which is picked up by the onboard imaging apparatus, on a display screen.

2. Description of the Related Art

When a vehicle running forward (leading vehicle) is a large-sized vehicle such as a bus, a refrigerator van, etc. and meanwhile a vehicle behind the leading vehicle (following vehicle) is a small-sized or medium-sized vehicle, it is hard for a driver of the following vehicle to grasp the condition of the road ahead because the front view is blocked by the leading vehicle. Whereby, it often happens that the condition of the road ahead cannot be checked when the following vehicle gets ahead of or picks off the leading vehicle. If so, pedestrians or obstacles right before the leading vehicle delays to be found, and thereby an unexpected accident may be caused.

Consequently, as a related art, Japanese Patent Literature (Japanese Published Utility Model Application S58-149233) discloses a following technique. In this technique, a first reflection mirror is attached downward at a front edge of a roof of a vehicle (corresponds to the leading vehicle mentioned above); a second reflection mirror is attached downward at a rear edge of the roof of the vehicle; and a third reflection mirror is attached at the rear part of the vehicle so as to face an obliquely upward direction. With this, the first mirror reflects the front view of the leading vehicle and passes the reflected light to the rear part of the vehicle; the second reflection mirror reflects the reflected light to pass the reflected light to the bottom of the rear part of the vehicle; and the third reflection mirror reflects the reflected light towards the obliquely downward direction of the rear part of the vehicle. Thereby, the following vehicle can visually recognizes the mirror image of the third reflection mirror as the front view of the leading vehicle.

In the mirror image display of the sight ahead a vehicle, the mirror image becomes small when the reflection mirror is small. Consequentially, the recognition level of the pedestrians and the obstacles becomes extremely low. Therefore, it is necessary to mount a large-sized reflection mirror in order to enlarge the mirror image and enhance the recognition level. However, an increase in the size of the reflection mirror causes an increase in the wind pressure to the reflection mirror, which results in an increase in the air resistance. As a result, fuel consumption of the vehicle is increased. Furthermore, depending on the attaching position or posture of the reflection mirror, the running position of the following car capable of recognizing the mirror image of the reflection mirror is designated, and it becomes impossible to recognize the mirror image of the reflection mirror at the positions other than the designated running position. Therefore, the effect of using it is ruined. Furthermore, the driver of the following vehicle may be dazzled because the reflected light from the reflection mirror is too strong under the backlight condition of the sun or the like, so that it raises an issue in terms of the safety.

### SUMMARY OF THE INVENTION

The object of the present invention therefore is to enable a driver of a following vehicle whose sight ahead the vehicle is blocked to drive safely according to a display of an onboard display apparatus that is loaded on a leading vehicle, without influencing the fuel consumption of the leading vehicle.

In order to achieve the aforementioned object of the present invention, the onboard imaging apparatus according to the present invention comprises:

an onboard imaging camera for picking up an image of sight ahead a vehicle; and

an onboard display device for displaying a picked-up image that is picked up by the onboard imaging camera, wherein

the onboard display device is arranged at such a position of the vehicle that it can be visually recognized from a following vehicle.

The present invention displays the picked-up image of the sight ahead the vehicle on the onboard display device. Thus, driver of the following vehicle can recognize the image of the sight ahead the vehicle without causing an inconvenience, e.g. an increase in the fuel consumption of the vehicle due to an increase of the wind pressure, unlike the conventional cases where the reflection mirrors are used. Further, the picked-up images displayed on the onboard display device can be visually recognized from many following vehicles, so that the effect of using it is tremendously enhanced. Furthermore, the drivers of the following vehicles can easily recognize the picked-up images of the sight ahead the vehicles, which are displayed on the onboard display device, even under a backlight condition.

As a preferable embodiment of the present invention, the onboard imaging apparatus further comprises an image processor for generating an image signal based on the picked-up image of the sight ahead the vehicle, which is picked up by the onboard imaging camera, wherein

the onboard display device displays an image based on the image signal generated by the image processor.

Another preferable embodiment of the present invention is that the onboard imaging camera can adjust a field angle of the picked-up image in the onboard imaging apparatus; and

the onboard imaging camera adjusts the field angle in such a manner that size of a subject in front of the vehicle becomes consistent with size of the subject displayed on the onboard display device when it is viewed from the following vehicle.

Alternatively, the image processor is capable of performing enlarging/reducing adjustment on the picked-up image; and

the image processor performs the enlarging/reducing adjustment on the picked-up image in such a manner that size of a subject in front of the vehicle becomes consistent with size of the subject displayed on the onboard display device when it is viewed from the following vehicle.

According to this embodiment, as it is possible to adjust the image size in accordance with the recognized size of the pedestrian or the obstacle, the driver of the following vehicle can recognize the distance to the pedestrian, the size of the obstacle, etc. from the image size. Therefore, the driver of the following vehicle can properly deal with the situation.

A preferable embodiment of the present invention is that the image processor is capable of adjusting display brightness of the onboard display device. According to this embodiment, it becomes possible to display a dazzling subject image with a proper brightness made not too bright through adjusting the maximum value of the display brightness in advance, even if there is the dazzling subject image present in the image of the sight ahead the vehicle.

In another preferable embodiment of the present invention, a plurality of the onboard imaging cameras whose imaging directions differ from each other in a horizontal direction, is provided as the onboard imaging apparatus;

the image processor generates an image signal that is constituted by synthesizing picked-up images that are captured by the plurality of onboard imaging cameras in a state being lined in parallel horizontally along each of the imaging directions of the plurality of onboard imaging cameras; and

the onboard display device displays an image based on the image signal that is obtained by synthesizing the images by the image processor.

Alternatively, a plurality of the onboard imaging cameras whose imaging directions differ from each other in a horizontal direction is provided as the onboard imaging apparatus;

a plurality of onboard display devices that are arranged in parallel along a horizontal direction, is provided as the onboard display device;

the image processor performs signal processing individually on image signals that are generated based on picked-up images captured by the plurality of onboard cameras, and supplies the plurality of image signals to respective onboard display devices that are arranged at positions in accordance with the imaging directions; and

the onboard display devices display images based on the image signals supplied from the image processor.

According to this embodiment, the picked-up images of the sight ahead the vehicle can be displayed in accordance with the running position of the following vehicle by mounting the imaging cameras at the center of the vehicle and in the vicinities of the side areas being away from the center. Therefore, more natural picked-up images can be provided to the driver of the following vehicle.

A preferable embodiment of the present invention is the one that the image processor performs image processing so that an image area to be emphasized can be displayed emphatically among the picked-up image that is displayed on the onboard display device. According to this embodiment, the pedestrian or the like can be recognized among the picked-up image and the pedestrian images can be superimposed, for example, for display. Thereby, when the leading vehicle is a large-sized vehicle, the driver of the following vehicle can easily recognize that there is a pedestrian in front of the large-sized leading vehicle. Thus, it is possible for the driver of the following vehicle to predict the danger at an early stage. Therefore, the driver of the following vehicle can drive safely even when the large-sized leading vehicle suddenly changes its way.

A preferable embodiment of the present invention is the one that the onboard imaging apparatus comprises a transmitter for radio-transmitting the image signal that is processed by the image processor, wherein

the onboard display device as well as a receiver for receiving the image signal that is radio-transmitted from the transmitter are mounted on the following vehicle, and a picked-up image that is generated based on the image signal received by the receiver is displayed on the onboard display device.

According to this, not only the vehicle running right behind the leading vehicle, but also a great number of following vehicles can recognize the road condition ahead the leading vehicle at once.

A preferable embodiment of the present invention is the one that the onboard imaging apparatus further comprises a sensor for detecting presence of a pedestrian in front of the vehicle, and an starting equipment, wherein

the starting equipment activates the onboard imaging apparatus when the sensor detects the pedestrian.

According to this, the system is activated only when the pedestrian or the like crosses before the leading vehicle. Thus, the running cost of the onboard imaging apparatus can be saved.

As described above, the present invention does not require a large-sized reflection mirrors or the like to be equipped on the leading vehicle. Thus, an increase in the fuel consumption that is caused due to providing the reflection mirrors can be prevented. Further, the image of the sight ahead the vehicle from the onboard imaging camera, is displayed on the onboard display device so that it is possible to provide the easily recognizable images without distortion, unlike the case of using the reflection mirrors. Therefore, the drivers of the following vehicles can accurately grasp the road condition ahead the vehicles so as to enable safe driving.

The present invention provides the onboard imaging apparatus that allows the driver of the following car to grasp the road condition ahead the vehicle, even if the view ahead the vehicle is blocked by the leading vehicle.

### BRIEF DESCRIPTION OF THE DRAWINGS

The objects, advantages and other novel features of the present invention will become clear from the following description of the preferred embodiments and the appended claims. Those skilled in the art will appreciate that there are many other advantages of the present invention by embodying the present invention.

FIG. 1 is a diagram showing the structure of an onboard imaging apparatus according to an embodiment of the present invention;

FIG. 2 is a diagram showing an onboard display screen that is mounted at the rear part of a leading vehicle shown in FIG. 1;

FIG. 3 is a diagram showing the structure of the onboard imaging apparatus;

FIG. 4A is a diagram showing a pedestrian as a subject;

FIG. 4B is a diagram showing a case where the pedestrian shown in FIG. 4A is displayed on the onboard display screen;

FIG. 4C is a diagram showing a case where the pedestrian shown in FIG. 4A is displayed on the onboard display screen;

FIG. 5A is a diagram showing a display example of the onboard display screen when backlight of the sun is displayed therein;

FIG. 5B is a diagram showing the luminance control under backlight condition as in FIG. 5A;

FIG. 6A is a diagram showing a case where images are picked up by a plurality of imaging apparatuses;

FIG. 6B is a diagram showing a display example of the onboard display screen in the case of FIG. 6A;

FIG. 7A is a diagram for describing a case where the pedestrian is highlighted;

FIG. 7B is a diagram showing a case where the pedestrian in FIG. 7A is displayed emphatically on the onboard display screen; and

FIG. 8 is a diagram showing a modification example of the present invention.

### DETAILED DESCRIPTION OF THE INVENTION

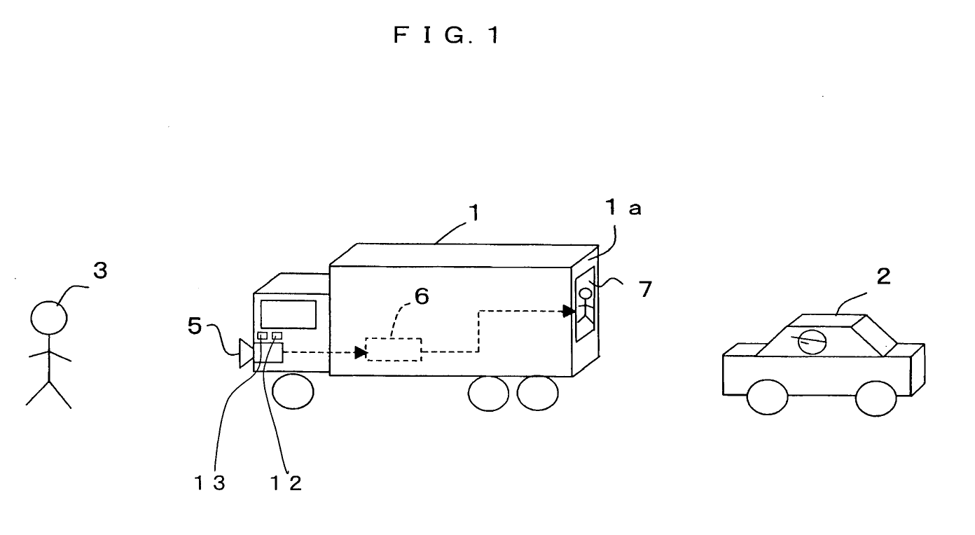

Hereinafter, an onboard imaging apparatus according to an embodiment of the present invention will be described in detail referring to the accompanying drawings. As shown in FIG. 1, a large-sized vehicle such as a refrigerator van runs on a road as a leading vehicle 1, and a medium/small-sized vehicle such as a passenger car runs as a following vehicle 2 behind the leading vehicle 1. FIG. 1 shows the state where the driver of the following vehicle 2 hardly recognizes or cannot recognize a pedestrian 3 who is walking on a road in front of the leading vehicle 1, because the leading vehicle 1 blocks the sight.

An onboard imaging apparatus 4 according to this embodiment is mounted on the leading vehicle 1 for enabling the driver of the following vehicle 2 to surely recognize the pedestrian 3 or others walking in front of the leading vehicle 1 so as to achieve safe driving under the road condition shown in FIG. 1. The onboard imaging apparatus 4 comprises: an onboard imaging camera 5 provided at the front part of the leading vehicle 1; an image processor 6 that generates and outputs a picked-up image based on an optical image of the sight ahead the vehicle, which is picked up by the onboard imaging camera 5; and an onboard display device 7 that is mounted in the rear end of the vehicle for displaying the picked-up image transmitted from the image processor 6.

The onboard imaging camera 5 picks up the front view of the leading vehicle 1, and the image processor 6 performs signal processing on the picked-up image signal that is generated based on an optical image of the sight ahead the vehicle, which is picked up by the onboard imaging camera 5. The picked-up image signal is transmitted to the onboard display device 7 where the front view of the leading vehicle 1 is displayed. The driver of the following vehicle 2 can recognize the pedestrian 3 in front of the leading vehicle 1 from a pedestrian image 3A in the picked-up image of the onboard display device 7 that is arranged at the rear part of the leading vehicle 1. Through this recognition, the driver of the following vehicle 2 can achieve safe driving even though the view ahead the vehicle is blocked by the leading vehicle 1.

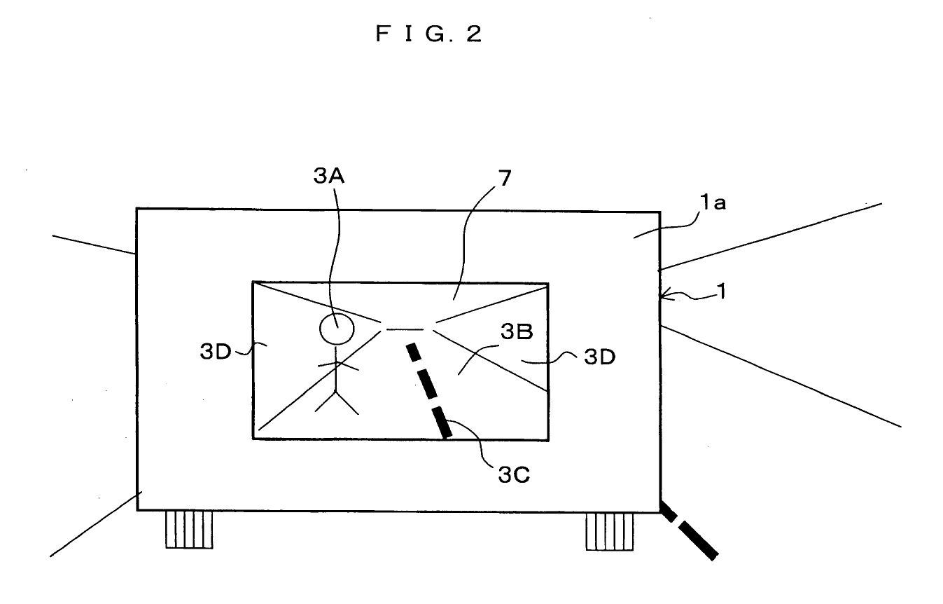

As shown in FIG. 2, the onboard display device 7 is mounted to a rear part 1a of the leading vehicle 1. The onboard display device 7 is a rectangular shape under a planar view. There is no limitation in a screen size, however, it is preferable that the pedestrian image 3A can be visually recognized from the position of the driver of the following vehicle 2.

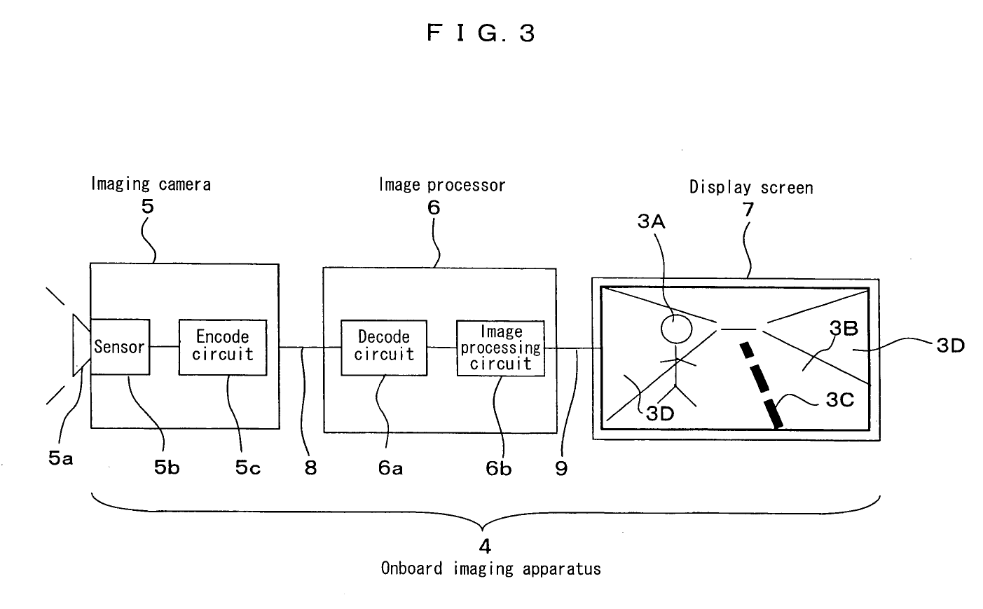

As shown in FIG. 3, the onboard imaging camera 5, the image processor 6, and the onboard display device 7 are connected to each other through signal-transmission relay cables 8 and 9. The onboard imaging camera 5 includes am imaging lens 5a, am imaging sensor 5b, and an encode circuit 5c. The imaging lens 5a is constituted with a zoom lens (view angle adjusting lens). The imaging sensor 5b is constituted with a CMOS sensor and the like, and it converts the optical image, which corresponds to the front view of the vehicle and is fetched through the imaging lens 5a, to an electric image signal, and outputs the image signal in real time. The encode circuit 5c encodes the image signal that is outputted from the imaging sensor 5b and outputs. The imaging lens 5a and the imaging sensor 5b of the imaging camera 5 are preferable to be set so that the focal point of the road surface that is the target of picking up images can be focused from the near side to the distant side.

The image processor 6 comprises a decode circuit 6a and an image processing circuit 6b. The decode circuit 6a decodes the image signal that is encoded by the encode circuit 5c. The image processing circuit 6b generates an picked-up image by performing various kinds of image processing, e.g. noise elimination, contrast control, gamma correction, color correction or the like, on the image signal that is decoded by the decode circuit 6a. It is preferable that a memory such as eDRAM, SDRAM, DDR-SDRAM or the like is provided in order to offer an image processing space of the image processing circuit 6b. In the image processing circuit 6b, resize processing, gain control and the like can be performed. It is preferable that the onboard display device 7 is constituted with a CRT display, LCD display, plasma display, EL display or the like, and it displays the picked-up image that is outputted from the image processor 6.

The onboard imaging apparatus 4 comprising the structures described above provides the front view of the leading vehicle 1 to the following vehicle 2 by displaying the picked-up image of the front view of the vehicle that is blocked by the leading vehicle 1 on the onboard display device 7 attached at the rear end of the leading vehicle 1. In the display example of the onboard display device 7 shown in FIG. 2, a road-surface image 3B, a white-line image 3C for dividing the road into lanes and obstacle images 3D on left and right sides are displayed. Within the display, the pedestrian image 3A is displayed. The driver of the following vehicle 2 can drive safely, while visually recognizing the view ahead the leading vehicle 1 through the image displayed on the onboard display device 7.

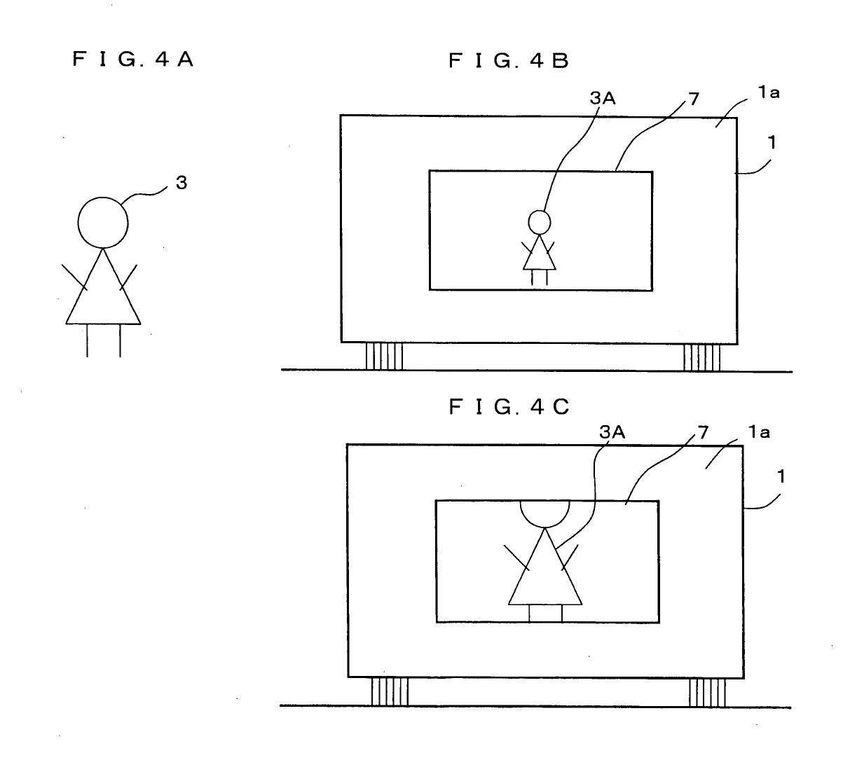

The size of the pedestrian image 3A on the onboard display screen 7 will be described referring to FIG. 4A-FIG. 4C. FIG. 4A shows the recognized size of the pedestrian 3 that is visually recognized by the driver of the following vehicle 2. FIG. 4B and FIG. 4C show the image size of the pedestrian image 3A on the onboard display screen 7 when visually recognized by the driver of the following vehicle 2. As clear from the comparison of the FIG. 4A and FIG. 4B, the image size in FIG. 4B is smaller than the recognized size. That is, because the recognized size is not consistent with the image size, it is not necessarily easy for the drover of the following vehicle to grasp the distance from the own vehicle to the pedestrian 3. Furthermore, it is also not necessarily easy to recognize the size of the obstacle when the subject is not the pedestrian 3 but an obstacle.

In the meantime, as clear from the comparison of FIG. 4A and FIG. 4C, the recognized size of the pedestrian 3 is consistent with the image size of the pedestrian image 3A in FIG. 4C, and it provides a display that is corresponded to the actual size perceived by the driver. By performing display on the onboard display device 7 based on this display size basis, it becomes easy for the driver of the following vehicle 2 to grasp the distance from the own vehicle to the pedestrian 3 that is hidden by the leading vehicle 1. In the case where the subject is not the pedestrian 3 but the obstacle, it is also possible to recognize the distance from the own vehicle to the obstacle that is hidden by the leading vehicle 1 and to recognize the size by achieving display with the same display size basis that is defined for the pedestrian 3. Such adjustment of the display size can be achieved by adjusting the zoom ratio (angle of view) of the imaging lens 5a. Further, when the image processor 6 is constituted with a digital signal processing circuit, the display size can also be adjusted by the digital signal processing.

A specific example of providing the image shown in FIG. 4C will be described. When a display device having a display screen that covers the entire panel face of the rear part 1a of the leading vehicle 1 (it is assumed to be a track in this case) is set up as the onboard display device 7, the zoom ratio is set in such a manner that the imaging field angle of the onboard imaging camera 5 becomes the so-called standard angle of view (55 mm for 35 mm film camera). Thereby, the distance from the driver of the following vehicle 2 to the video (the video of the sight ahead the leading vehicle 1) displayed on the onboard display device 7 becomes almost the same as the actual distance from the driver's eye. Based on this view point, the zoom ratio of the onboard imaging camera 5 is set in accordance with the ratio of the panel area of the rear part 1a of the leading vehicle 1 to the display screen area of the onboard display device 7. That is, in the state where the ratio of the panel area to the display screen is 1:1 (having the same area with respect to each other), the zoom ratio is set to be in the so-called standard angle of view. Meanwhile, the zoom ratio is set to be a telescopic field angle (110 mm for 35 mm film camera) that is twice the standard, when the ratio of the panel area to the display screen is 2:1 (the display area is a half the panel area). According to this, it is possible to provide the image shown in FIG. 4C. Adjustment of the zoom ratio in this case may be optically performed in the onboard imaging camera 5 or may be performed by the digital signal processing performed in the signal processor 6.

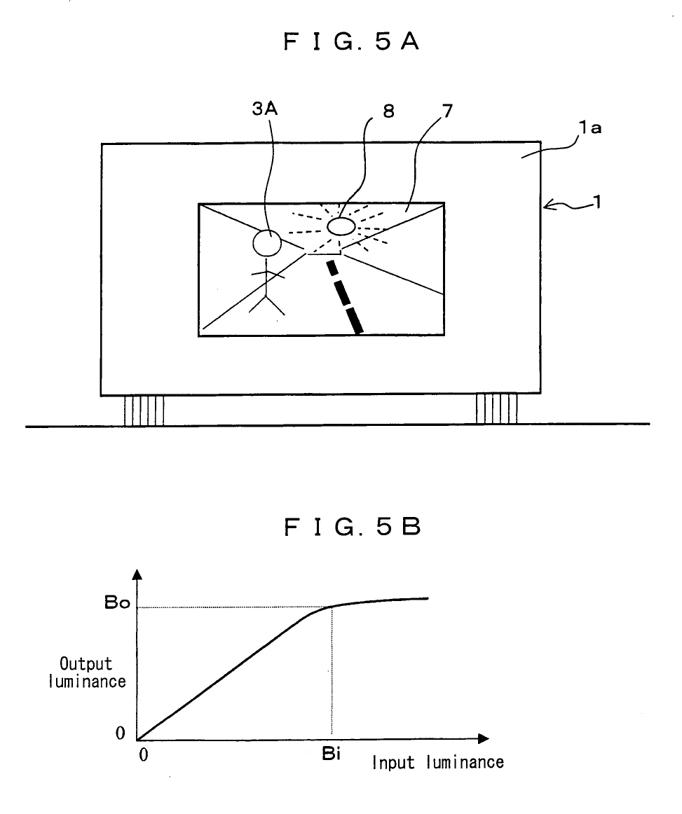

Referring to FIG. 5A and FIG. 5B, description will be given to the display of the onboard display device 7 under a backlight condition where the leading vehicle 1 and the following vehicle 2 are running towards the forward backlight (intense light beams) of the sun or the like. When running under a backlight condition, the exposure condition of the onboard imaging camera 5 cannot follow up with that condition, so that it is not possible to pick up the image in front of the vehicle properly. In FIG. 5A, the pedestrian image 3A and the sun image 8 are displayed on the onboard display device 7 of the leading vehicle 1 as the view ahead the vehicle. The sun is so bright that it is difficult for the driver of the following vehicle 2 to see the onboard display screen 7. Thus, in the image processor 6, the imaging screen of the onboard display device is divided into a plurality of blocks, and automatic intensity control is carried out to decrease the intensity in the block where the intensity becomes high due to the backlight or the like. In that case, as shown in FIG. 5B, for example, when the input intensity of the picked-up image within a given block reaches a threshold value Bi or higher, the image processor 6 restricts the output intensity of the picked-up image in that block to a threshold value Bo. According to this, the intensity of the displayed image in the onboard display screen 7 is prevented to be more than a specific value as a whole, so that the driver of the following vehicle 2 can recognize the pedestrian image 3A on the onboard display screen 7 without being dazzled by the sun image 8 on the display. Thus, the driver of the following vehicle 2 can achieve safe driving by expecting the presence of the pedestrian 3 ahead the vehicle. Inversely, as the intensity becomes insufficient when the vehicles are in a dark place within a tunnel, the image processor 6 may carry out the intensity control to increase the intensity therein.

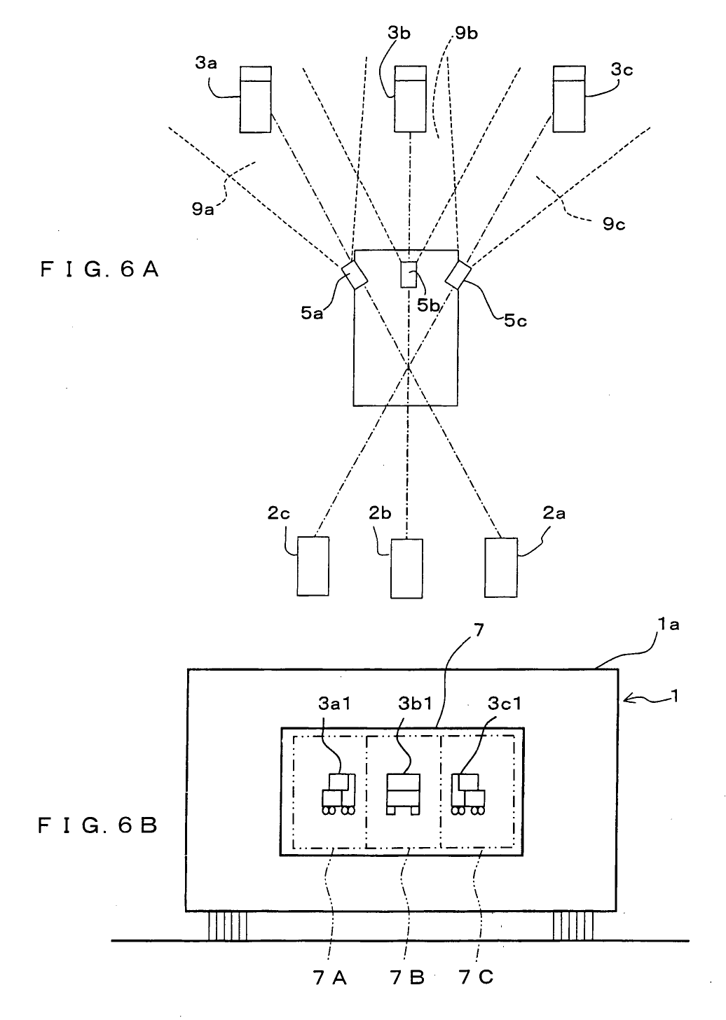

Referring to FIG. 6, description will be given to a case where a plurality of imaging cameras are mounted on the leading vehicle 1 to enable proper display of the sight ahead the vehicle on the onboard display screen 7 in accordance with the running position of the following vehicle 2. That is, as shown in FIG. 6A, three imaging cameras 5a, 5b, and 5c are mounted on the left side of the front part, the center of the front part and right side of the front part of the leading vehicle 1 respectively. The imaging camera 5a on the left side of the front part picks up a vehicle 3a running in the left front side of the leading vehicle 1, the imaging camera 5b in the center of the front part picks up a vehicle 3b running in the center in front of the leading vehicle 1, and the imaging camera 5c on the right side of the front part picks up a vehicle 3c running in the right front side of the leading vehicle 1. The imaging ranges of the imaging cameras 5a, 5b and 5c are 9a, 9b and 9c respectively. As shown in FIG. 6B, in the onboard display device 7, the image processor 6 synthesizes images 3a1, 3b1, and 3c1 of the respective vehicles 3a, 3b, 3c that are picked up by the imaging cameras 5a, 5b, 5c to be displayed on the onboard display screen 7. Thereby, the image 3a1 of the vehicle 3a in the left front side of the leading vehicle 1, which is not displayed by only the imaging camera 5b provided in the center, is displayed on the onboard display screen 7 for the driver of a following vehicle 2a that is running on the right rear side of the leading vehicle 1. Further, the image 3c1 of the vehicle 3c in the right front side of the leading vehicle 1, which is not displayed by only the imaging camera 5b provided in the center, is displayed on the onboard display screen 7 for the driver of a following vehicle 2c that is running on the left rear side of the leading vehicle 1. Therefore, each of those drivers can achieve safe driving. The onboard display device 7 may have a single screen, may have the divided screens for display, or may be such a type in which a single image is arranged in every three pixels, and the directivity is secured with an optical filter so as to allow the three pixels to be recognized from different directions in a single screen. Alternatively, as shown in FIG. 6B with virtual lines, a plurality of display devices 7A, 7B and 7C may be provided to correspond individually in accordance with each of the imaging cameras 5a, 5b and 5c. When a plurality of onboard display devices 7 are provided, it is unnecessary for the image processor 6 to synthesize a plurality of images 3a1, 3b1, and 3c1. The image processor 6 only needs to perform signal processing individually on each of the images 3a1, 3b1, 3c1, and supply them to each of the onboard display devices 7.

In this display example of the onboard display device 7, the view ahead the leading vehicle 1 can be displayed in accordance with the relative positional relation of the following vehicle 2 to the leading vehicle 1. Thus, more natural image can be provided to the driver of the following vehicle 2.

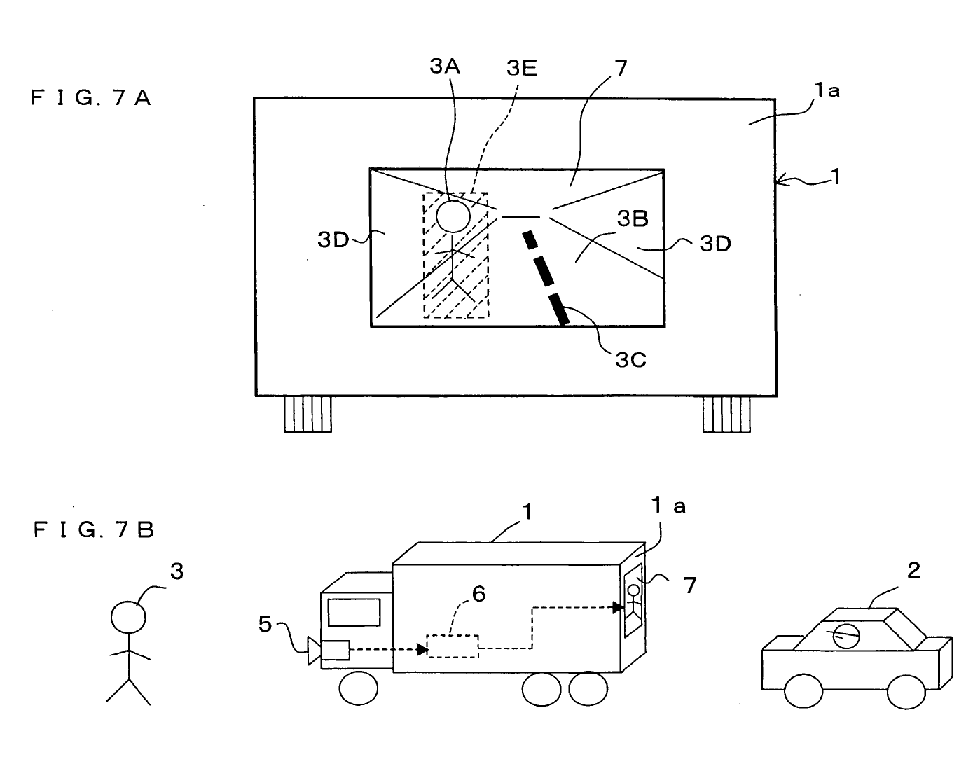

Referring to FIG. 7, a case of an emphatic display on a specific subject among the view ahead the leading vehicle 1 will be described. In FIG. 7A, the pedestrian 3 is walking in front of the leading vehicle 1 as a specific subject. By emphatically displaying the pedestrian image 3A in the onboard display device 7, the driver of the following vehicle 2 can recognize the pedestrian image 3A more easily. Thus, it is preferable in terms of achieving safe driving.

There are the following ways for emphatically displaying.
perform superimposing processing by surrounding the pedestrian image 3A with broken lines 3E (OSD: onscreen display processing)
displays the surrounded area in a state of flashing
changes the intensity or the chromaticity of the surrounded area

The image processor 6 stores various kinds of information on the subjects (shape information, color information, etc.) as a table in processing the video signals that are transmitted from the imaging camera 5. When the subject is determined as the pedestrian 3 in the process of carrying out the processing on the video signals from the imaging camera 5, the image processor 6 displays the pedestrian image 3A emphatically the onboard display device 7. It is necessary to perform image processing (subject recognition) on such pedestrian image 3A in real time. Such image processing can be performed by measuring an amount of feature in accordance with the state of the subject. The amount of feature, for example, refers to the color or the intensity level of the subject. Measurements thereof can be carried out by analytical processing where the shape of the subject is analyzed, or by measurement based on the reflectance of the intensity level, etc. For a moving subject, it can be detected by separating the moving subject from the still image in the background. For example, each of frame images that constitute the moving image is lined in a time series, a difference between the position of the subject in the previous frame and the latter frame is detected, and the difference generated thereby is outputted. Based on the output, the specific subject can be detected. Alternatively, the specific subject can be made recognizable as an image based on thermal information through irradiating infrared rays to the subject from the front side of the leading vehicle 1.

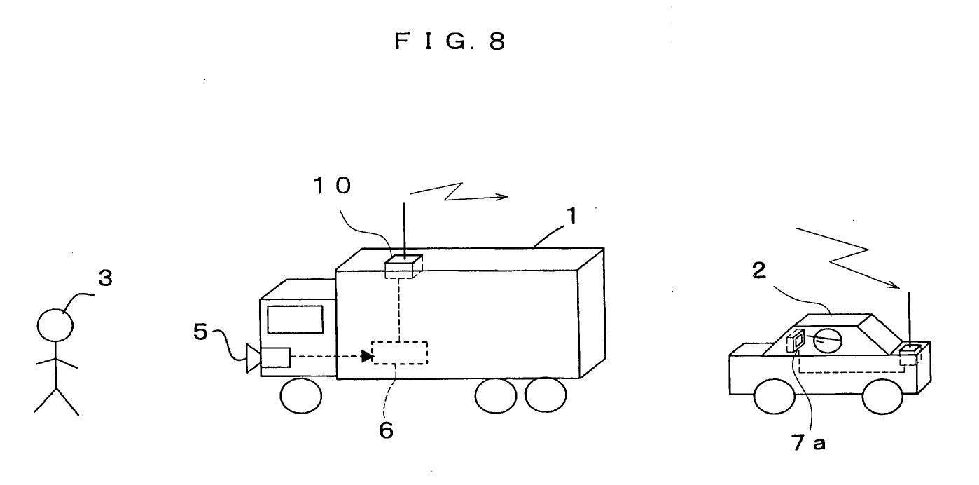

In the embodiment described above, the onboard display device 7 is mounted at the rear part 1a of the leading vehicle 1. However, instead of mounting the onboard display device 7 in the leading vehicle 1, the present invention can be achieved also in the following manner. As shown in FIG. 8, an image picked up by the imaging camera 5 mounted in the leading vehicle 1, and then signal-processed into an image signal by the image processor 6, may be transmitted to the following vehicle 2 from the leading vehicle 1 with a transmitter 10 through radio communication. In the following vehicle 2, the image signal may be received by a receiver 11, and may be displayed on an onboard display device 7a that belongs to a navigation device or the like mounted on the own vehicle. For example, the image signal received through the radio communication can be processed in an image processing part of the car navigation control unit to display it on the onboard display device of a car navigation system. By doing so, not only a single or several following vehicles 2 running right after the leading vehicle 1, but also a great number of following vehicles 2 can recognize the road condition ahead the leading vehicle 1 at once.

In addition, the present invention can be achieved by leaving the activation of the system of the onboard imaging apparatus 4 that is mounted on the leading vehicle 1 to the driver of the leading vehicle 1 to decide voluntarily. Alternatively, as shown in FIG. 1, a pedestrian sensor 12 and an starting equipment 13 may be mounted on the leading vehicle 1, so that the starting equipment 13 can activate the system of the onboard imaging apparatus 4 when the sensor 12 detects a pedestrian. Either an acoustic sensor or a thermal sensor may be used as the pedestrian sensor 12.

Further, instead of using a plurality of imaging cameras whose imaging ranges are limited, an imaging camera capable of imaging multiple directions may be used as the imaging camera. That is, there are blind spots in the imaging range of the imaging camera, so that the pedestrian may not be displayed on the onboard display device even if there is a pedestrian, for example, in front of the vehicle. In order to avoid it, a mirror having a plurality of reflecting planes may be arranged in front of the imaging lens. Through receiving the light rays reflected by the mirror from a plurality of directions from the front side of the vehicle, and forming an image on the imaging device, it is possible to pickup the images in the multiple directions.

The present invention has been described in detail referring to the most preferred embodiments. However, various combinations and modifications of the components are possible without departing from the spirit and the broad scope of the appended claims.

What is claimed is:

1. An onboard imaging apparatus, comprising:
an onboard imaging camera for picking up an image of sight ahead of a vehicle; and
an onboard display device for displaying a picked-up image that is picked up by said onboard imaging camera, wherein said onboard display device is arranged at such a position of said vehicle that it can be visually recognized from a following vehicle.

2. The onboard imaging apparatus according to claim 1, wherein said onboard display device is provided at a rear part of said vehicle.

3. The onboard imaging apparatus according to claim 1, further comprising an image processor for generating an image signal based on said picked-up image of sight ahead said vehicle, which is picked up by said onboard imaging camera, wherein
said onboard display device displays an image generated based on said image signal generated by said image processor.

4. The onboard imaging apparatus according to claim 1, wherein:
said onboard imaging camera can adjust a field angle of said picked-up image; and
said onboard imaging camera adjusts said field angle in such a manner that size of a subject in front of said vehicle when viewed from said following vehicle becomes consistent with size of said subject displayed on said onboard display device.

5. The onboard imaging apparatus according to claim 3, wherein:
said image processor is capable of performing enlarging/reducing adjustment on said picked-up image; and
said image processor performs said enlarging/reducing adjustment on said picked-up image in such a manner that size of a subject in front of said vehicle when viewed from said following vehicle becomes consistent with size of said subject displayed on said onboard display device.

6. The onboard imaging apparatus according to claim 1, wherein said image processor is capable of adjusting display luminance of said onboard display device.

7. The onboard imaging apparatus according to claim 3, wherein:
said onboard imaging camera consists of a plurality of onboard imaging cameras whose imaging directions differ from each other in a horizontal direction;
said image processor generates an image signal that is constituted by synthesizing picked-up images, that are captured by said plurality of onboard imaging cameras, in a state of being lined in parallel along each of said imaging directions of said plurality of onboard imaging cameras; and
said onboard display device displays an image generated based on said image signal that is obtained by synthesizing said images by said image processor.

8. The onboard imaging apparatus according to claim 3, wherein:
said onboard imaging camera consists of a plurality of onboard imaging cameras whose imaging directions differ from each other in a horizontal direction;
said onboard display device consists of a plurality of onboard display devices that are arranged in parallel along a horizontal direction;
said image processor performs signal processing individually on image signals that are generated based on picked-up images captured by said plurality of onboard cameras, and supplies said plurality of image signals to respective onboard display devices that are arranged at positions in accordance with said imaging directions; and
said onboard display devices display images generated based on said image signals supplied from said image processor.

9. The onboard imaging apparatus according to claim 3, wherein said image processor performs image processing so that an image area to be enhanced can be displayed emphatically in said picked-up image that is to be displayed on said onboard display device.

10. The onboard imaging apparatus according to claim 3, comprising a transmitter for radio-transmitting said image signal that is processed by said image processor, wherein
not only said onboard display device but also a receiver for receiving said image signal that is radio-transmitted from said transmitter, are mounted on said following vehicle, and a picked-up image generated based on said image signal received by said receiver is displayed on said onboard display device.

11. The onboard imaging apparatus according to claim 1, further comprising a sensor for detecting presence of a pedestrian in front of said vehicle, and an starting equipment, wherein
said starting equipment activates said onboard imaging apparatus when said sensor detects said pedestrian.
